(19) United States
(12) Patent Application Publication
(10) Pub. No.: US 2024/0373535 A1
(43) Pub. Date: Nov. 7, 2024

(54) RENDERING OF A MULTI-COLOR LIGHT EFFECT ON A PIXELATED LIGHTING DEVICE BASED ON SURFACE COLOR

(71) Applicant: SIGNIFY HOLDING B.V., EINDHOVEN (NL)

(72) Inventors: HUGO JOSÉ KRAJNC, EINDHOVEN (NL); DZMITRY VIKTOROVICH ALIAKSEYEU, EINDHOVEN (NL)

(21) Appl. No.: 18/688,414

(22) PCT Filed: Aug. 29, 2022
(86) PCT No.: PCT/EP2022/073893

§ 371 Date: Mar. 1, 2024

(30) Foreign Application Priority Data
Sep. 2, 2021 (EP) 21194579.5

(51) Int. Cl. H05B 47/175; H05B 45/20

(52) U.S. Cl. CPC H05B 47/196; H05B 45/20

(57) ABSTRACT

A system for controlling a pixelated lighting device (10) which comprises individually controllable light segments (12-18) for illuminating a surface (61) is configured to receive one or more signals indicative of one or more colors (64,65) of the surface and obtain a multi-color light effect to be rendered on the pixelated lighting device. The multi-color light effect defines multiple color values (71-79) to be rendered simultaneously. The system is further configured to determine an assignment of the color values to the individually controllable light segments based on the one or more colors of the surface and/or adjust a dynamicity level of the multi-color light effect based on the one or more colors of the surface, and to control the individually controllable light segments of the pixelated lighting device to render the multi-color light effect according to the assignment and/or with the adjusted dynamicity level.

### FIELD OF THE INVENTION

The invention relates to a system for controlling a pixelated lighting device, said pixelated lighting device comprising a plurality of individually controllable light segments for illuminating a surface.

The invention further relates to a method of controlling a pixelated lighting device, said pixelated lighting device comprising a plurality of individually controllable light segments for illuminating a surface.

The invention also relates to a computer program product enabling a computer system to perform such a method.

### BACKGROUND OF THE INVENTION

Smart lighting allows users to create different ambiances and scenes in spaces of their home. Sometimes, these scenes contain a single or reduced color gamut (e.g., relaxing scenes with white low intensity yellow light or concentrating scenes with high intensity cool white light). However, other times, users choose to deploy scenes which contain multiple colors, for example as part of a color palette extracted from images, or simply manually selected to define a preferred setting chosen by the user. US 2020/041082 A1 discloses an example of the former.

US 2020/041082 A1 discloses a lighting fixture which includes a light source configured to emit a light toward an area. The lighting fixture further includes a receiver configured to receive an image of the area. The lighting fixture also includes a controller device configured to adjust a color or a color temperature of the light emitted based on at least color content of the image.

WO2021/058191 A1 discloses a method of illuminating an artwork in an exposition area is disclosed. The artwork is illuminated with a lighting system comprising one or more light fixtures configured to emit light with variable characteristics as a function of a control command, wherein a light sensor is installed in the exposition area in order to measure a global and/or a plurality of local light intensity values of the light reflected by the artwork for at least one wavelength or wavelength range.

The rendering of multi-color light scenes gets enriched with pixelated lighting devices, which allow a higher density of color changes within a single device. For example, panels and light strips can now generate more than one color along their surface/length, allowing for smoother gradients rather than more discrete effects.

The benefit of pixelated lighting devices in terms of being able to generate light across distances means that it can also run into previously less impactful problems. For example, if a light strip is placed such that it shines against a wall (to provide indirect lighting), there is a higher likelihood that the background color of that wall does not remain constant throughout the length of the strip. This means that the lighting effect that is generally designed to be shone against a neutral white background might have undesired color mixing effects if the background is not neutral white. This can impair the ambiance generation ability of the light strip.

### SUMMARY OF THE INVENTION

It is a first object of the invention to provide a system, which is able to control a pixelated lighting device to render a multi-color light effect with reduced effect of the background color on the created ambience.

It is a second object of the invention to provide a method which can be used to control a pixelated lighting device to render a multi-color light effect with reduced effect of the background color on the created ambience.

In a first aspect of the invention, a system for controlling a pixelated lighting device, said pixelated lighting device comprising a plurality of individually controllable light segments for illuminating a surface, comprises at least one input interface, at least one control interface, and at least one processor configured to receive, via said at least one input interface, one or more signals indicative of one or more colors of said surface, obtain a multi-color light effect to be rendered on said pixelated lighting device, said multi-color light effect defining multiple color values to be rendered simultaneously, determine an assignment of said color values to said individually controllable light segments based on said one or more colors of said surface and/or adjust a dynamicity level of said multi-color light effect based on said one or more colors of said surface, and control, via said at least one control interface, said individually controllable light segments of said pixelated lighting device to render said multi-color light effect according to said assignment and/or with said adjusted dynamicity level.

By shifting color gradients and/or adjusting the dynamicity level of dynamic effects, the effect of the surface color on the rendered multi-color light effect may be reduced. If a color gradient light effect needs to be rendered, the system may move the gradient along the length of the strip such that the most suitable colors are co-located close to the area of the wall where the effect can suffer the least. For example, if the user wants to deploy a rainbow gradient, the system may ensure that the pixels (light segments) that take up the yellow, orange, and lime colors are the ones against the yellow wall, as then the natural color of the wall helps in enhancing those colors, whereas if blue and green had been placed there, the contrast would have impacted the ambiance created.

If a dynamic multi-color light effect needs to be rendered, this dynamic light effect may look different depending on the color of the surface. For example, if a fireplace effect is being deployed as a dynamic scene against a white wall, it might look to be acting faster than if the fireplace effect would be deployed against a pale yellow wall. By increasing the dynamicity level of the fireplace effect when deployed against a pale yellow wall, the light effect may be rendered in a uniform manner independent of the color of the wall.

Said dynamic multi-color light effect may generated by the system, by the user, or may be driven by (other) content like music or a movie. Said dynamicity level may be represented by a transition time between successive light settings in a dynamic light effect and/or a contrast between successive light settings in said dynamic light effect.

Said one or more signals may be indicative of a first color of a first section of said surface and a second color of a second section of said surface, said first and second colors being different, and said at least one processor may be configured to determine said assignment of said color values to said individually controllable light segments based on said first and second colors of said first and second sections of said surface and/or adjust said dynamicity level of said multi-color light effect based on said first and second colors of said first and second sections of said surface.

As previously mentioned, a lighting effect that is generally designed to be shone against a neutral white background might have undesired color mixing effects if the background is not neutral white. This is especially the case in the sections where the wall's background color changes.

Said at least one processor may be configured to determine a location of a boundary between said first and second sections of said surface based on said one or more signals and determine said assignment of said color values to said individually controllable light segments further based on said location of said boundary and/or adjust said dynamicity level of said multi-color light effect further based on said location of said boundary. Knowing the location of the boundary makes it possible to determine which light segments of the pixelated lighting device illuminate which section of the surface.

Said multi-color light effect may be a dynamic light effect, said dynamicity level may be associated with said dynamic light effect, and said at least one processor may be configured to obtain a first dynamicity level for a first segment of said individually controllable light segments based on said first color and said dynamicity level and a second dynamicity level for a second segment of said individually controllable light segments based on said second color and said dynamicity level.

Dynamic light effects may look worse if there is a transition in the color and/or texture of the surface. For example, if a fireplace effect is being deployed as a dynamic scene, the light illuminating a white section of the wall the white wall might look to be acting faster than the light illuminating a pale yellow section of the wall. The system may then adjust the dynamicity level of certain light segments to make the overall ambiance feel uniform throughout. For example, the pixels against the pale yellow wall could fluctuate faster, and optionally with higher brightness. Similarly, a section of the wall that has a rough surface might also make a dynamic multi-color light effect look more dynamic than a section of the wall that has a smooth surface.

As described above, said multi-color light effect may comprise a color gradient. Said at least one processor may be configured to determine said assignment by mapping a start of said color gradient to one of said individually controllable light segments based on said one or more colors of said surface and mapping an end of said color gradient to a further one of said individually controllable light segments based on said one or more colors of said surface.

Alternatively or additionally, said at least one processor may be configured to determine said assignment by selecting a segment of said color gradient and selecting one or more of said individually controllable light segments based on said one or more colors of said surface and control said individually controllable light segments of said pixelated lighting device by controlling said one or more selected light segments to render said segment of said color gradient. In this way, color gradients are not only shifted but one or more segments of the color gradient are also shrunk or expanded.

In certain situations, the distribution of pixels along the different segments of the surface, and the corresponding mapping of pixels is not sufficient to allow the shifting of gradients to be enough of a fix. For example, if the user wants to deploy a rainbow gradient, the system may ensure that the pixels that take up the yellow, orange, and lime colors are the ones against the yellow wall, but if the density of colors is high enough that even if yellow, orange, and lime would be shifted towards the pixels against the pale yellow wall, there would still have been green and red pixels within that area and this would have still broken the ambiance being created.

As a solution to this, the system may shrink or expand the gradients of different sections. This means that segments of pixels will no longer have uniform distributions but instead some colors will be deployed among more pixels whereas others among fewer. In the previous example, more pixels may be used to cover the yellow, orange, and lime pixels, while fewer may be used to cover red, blue, and green in the remaining parts of the pixelated lighting device.

Said at least one processor may be configured to determine color distances between each of said color values and each of said one or more colors of said surface and determine said assignment of said color values to said individually controllable light segments based on said color distances. For example, the color distances between the yellow, orange, and lime colors of a rainbow gradient and the yellow of the wall are smaller than the color distances between the blue and green colors of the rainbow gradient and the yellow of the wall and therefore the yellow, orange, and lime colors may be the ones shone on the yellow wall.

Said at least one processor may be configured to determine a degree of visibility for each of said individually controllable light segments and determine said assignment of said color values to said individually controllable light segments further based on said degrees of visibility and/or adjust said dynamicity level of said multi-color light effect further based on said degrees of visibility. If the degree of visibility of certain light segments is low, which color is rendered by these light segments does not impact the created ambience (much), which gives more freedom when selecting color values for these light segments.

Said one or more signals may be further indicative of one or more textures and/or one or more reflective properties of said surface and said at least one processor is configured to determine said assignment of said color values to said individually controllable light segments further based on said one or more textures and/or said one or more reflective properties of said surface and/or adjust said dynamicity level of said multi-color light effect further based on said one or more textures and/or said one or more reflective properties of said surface. This is beneficial because the texture(s) and/or one or more reflective properties of the surface may also impact the created ambience. For example, going from a smooth to a rugged surface will also affect the deployment of light on it.

Said multi-color light effect may further define brightness values associated with said multiple color values and said at least one processor may be configured to adjust one or more of said brightness values based on said one or more colors of said surface, and control said individually controllable light segments of said pixelated lighting device by controlling said individually controllable light segments to render said multi-color light effect with said adjusted one or more brightness values. For example, the pixels against a pale yellow wall could fluctuate faster and with higher brightness. Optionally, the one or more brightness values may further be adjusted based on more textures and/or one or more reflective properties of the surface. A rough non-reflective surface might need more brightness to seem similar than a smooth reflective one. Alternatively, the brightness values associated with the multiple color values may be kept unadjusted.

Said one or more signals may be indicative of plurality of colors and said at least one processor may be configured to receive said one or more signals from a sensor, determine a color by determining a dominant color in said plurality of colors and/or by selecting said color from said plurality of colors based on a location on said surface, said location being illuminated by said pixelated lighting device, and determine said assignment of said color values to said individually controllable light segments based on said color and/or adjust said dynamicity level of said multi-color light effect based on said color.

Determining a dominant color is beneficial if multiple colors are indicated for a single section of a surface and the surface is not painted to a uniform color. As a first example, the multiple colors may be interleaved and each of the light segments may illuminate a part of the surface that has both colors. As a second example, a wall may have a wallpaper with a pattern and the dominant color may be calculated to decide how to adjust colors of each light segment. Selecting a color from the plurality of colors based on a location on the surface is beneficial if the surface has different sections with different colors and the pixelated lighting device illuminates only one of these sections.

In a second aspect of the invention, a method of controlling a pixelated lighting device, said pixelated lighting device comprising a plurality of individually controllable light segments for illuminating a surface, comprises receiving one or more signals indicative of one or more colors of said surface, obtaining a multi-color light effect to be rendered on said pixelated lighting device, said multi-color light effect defining multiple color values to be rendered simultaneously, determining an assignment of said color values to said individually controllable light segments based on said one or more colors of said surface and/or adjust a dynamicity level of said multi-color light effect based on said one or more colors of said surface, and controlling said individually controllable light segments of said pixelated lighting device to render said multi-color light effect according to said assignment and/or with said adjusted dynamicity level. Said method may be performed by software running on a programmable device. This software may be provided as a computer program product.

Moreover, a computer program for carrying out the methods described herein, as well as a non-transitory computer readable storage-medium storing the computer program are provided. A computer program may, for example, be downloaded by or uploaded to an existing device or be stored upon manufacturing of these systems.

A non-transitory computer-readable storage medium stores at least one software code portion, the software code portion, when executed or processed by a computer, being configured to perform executable operations for controlling a pixelated lighting device, said pixelated lighting device comprising a plurality of individually controllable light segments for illuminating a surface.

The executable operations comprise receiving one or more signals indicative of one or more colors of said surface, obtaining a multi-color light effect to be rendered on said pixelated lighting device, said multi-color light effect defining multiple color values to be rendered simultaneously, determining an assignment of said color values to said individually controllable light segments based on said one or more colors of said surface and/or adjust a dynamicity level of said multi-color light effect based on said one or more colors of said surface, and controlling said individually controllable light segments of said pixelated lighting device to render said multi-color light effect according to said assignment and/or with said adjusted dynamicity level.

As will be appreciated by one skilled in the art, aspects of the present invention may be embodied as a device, a method or a computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system.” Functions described in this disclosure may be implemented as an algorithm executed by a processor/microprocessor of a computer. Furthermore, aspects of the present invention may take the form of a computer program product embodied in one or more computer readable medium(s) having computer readable program code embodied, e.g., stored, thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples of a computer readable storage medium may include, but are not limited to, the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of the present invention, a computer readable storage medium may be any tangible medium that can contain, or store, a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor, in particular a microprocessor or a central processing unit (CPU), of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of devices, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

### BRIEF DESCRIPTION OF THE DRAWINGS

These and other aspects of the invention are apparent from and will be further elucidated, by way of example, with reference to the drawings, in which:

FIG. 1 is a block diagram of a first embodiment of the system;

FIG. 2 is a block diagram of a second embodiment of the system;

FIG. 3 is a flow diagram of a first embodiment of the method;

FIG. 4 is a flow diagram of a second embodiment of the method;

FIG. 5 shows an example of a wall with two colors;

FIG. 6 is a flow diagram of a third embodiment of the method;

FIG. 7 is a flow diagram of a fourth embodiment of the method;

FIG. 8 shows an example assignment of values of a color gradient to segments of a light strip;

FIG. 9 is a flow diagram of a fifth embodiment of the method;

FIG. 10 shows an example in which a light strip is partly obscured by a bookcase;

FIG. 11 is a flow diagram of a sixth embodiment of the method; and

FIG. 12 is a block diagram of an exemplary data processing system for performing the method of the invention.

Corresponding elements in the drawings are denoted by the same reference numeral.

### DETAILED DESCRIPTION OF THE EMBODIMENTS

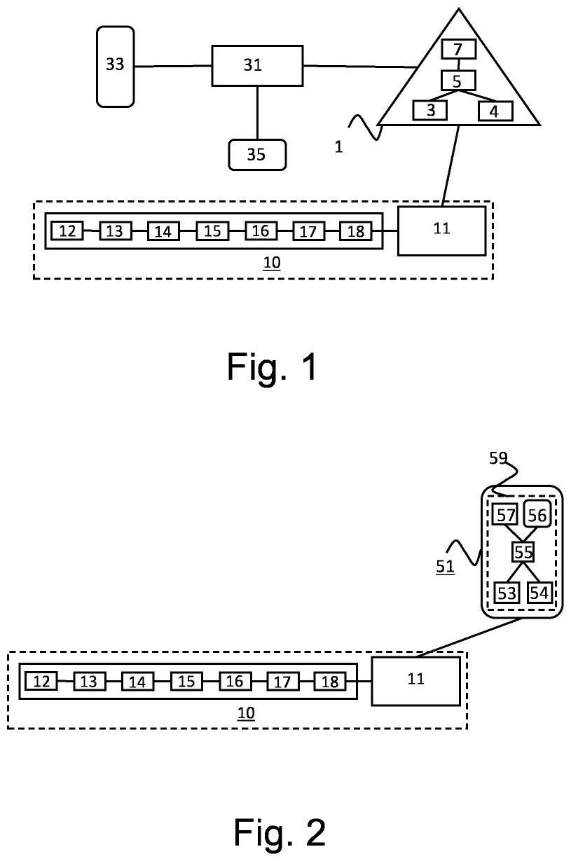

FIG. 1 shows a first embodiment of the system for controlling a pixelated lighting device. The pixelated lighting device comprises a plurality of individually controllable light segments for illuminating a surface. In this first embodiment, the system is a light controller 1, e.g., a Hue bridge. FIG. 1 depicts one pixelated lighting device: light strip 10. Light strip 10 comprises controller 11. Light strip 10 comprises seven individually controllable light segments 12-18. Each individually controllable light segment comprises one or more light sources, e.g., LED elements.

The light controller 1 and the light strip 10 can communicate wirelessly, e.g., via Zigbee. The light controller 1 is connected to a wireless LAN access point 31, e.g., via Ethernet or Wi-Fi. A mobile phone 33 is also able to connect to the wireless LAN access point 31, e.g., via Wi-Fi. The mobile phone 33 can be used to control the light strip 10 via the wireless LAN access point 31 and the light controller 1, e g. to turn the light segments of the light strips on or off or to change their light settings.

The light controller 1 comprises a receiver 3, a transmitter 4, a processor 5, and a memory 7. The processor 5 is configured to receive, via the receiver 3, one or more signals indicative of one or more colors of the surface and obtain a multi-color light effect to be rendered on a pixelated lighting device. The multi-color light effect defines multiple color values to be rendered simultaneously, e.g., a color gradient.

The processor 5 is further configured to determine an assignment of the color values to the individually controllable light segments 12-18 of the light strip 10 based on the one or more colors of the surface and/or adjust a dynamicity level of the multi-color light effect based on the one or more colors of the surface, and control, via the transmitter 4, the individually controllable light segments 12-18 of the light strip 10 to render the multi-color light effect according to the assignment and/or with the adjusted dynamicity level.

The processor 5 may be configured to determine color distances between each of the color values and each of the one or more colors of the surface and determine the assignment of the color values to the individually controllable light segments based on these color distances.

In the example of FIG. 1, the one or more signals are received by the processor 5 from a sensor 35 such as a camera. If the one or more signals are indicative of plurality of colors, this does not necessarily mean that the light strip 10 illuminates different sections of the surface which each have a different color. If the surface has different sections with different colors and the light strip 10 illuminates only one of these sections, the processor 5 may be able to select the relevant color. The processor 5 may be configured to select the color from the plurality of colors based on a location on the surface which is illuminated by the light strip 10.

It could also be the case that multiple colors are indicated for a single section of a surface due to the multiple colors being interleaved. In this case, each of the light segments may illuminate a part of the surface that has both colors. The processor 5 may be configured to determine a dominant color in the plurality of colors to allow the assignment of the color values to the individually controllable light segments 12-18 to be determined based on the dominant color and/or the adjustment of the dynamicity level of the multi-color light effect to be adjusted based on the dominant color.

If the one or more signals would be received from a user device, the one or more signals may already indicate the color of the specific section illuminated by the light strip 10 or the dominant color of the multi-colored section illuminated by the light strip 10. The one or more signals may be manually entered by the user, for example. Alternatively, the one or more signals may be the result of manual calibration, for example. The system may be manually calibrated without using a camera and without a user explicitly entering the color of the wall. In this case, the system could, for example, render light effects slightly changing their colors and ask a user to indicate when the effect looks whitest, which will allow the system to estimate the color of the wall. For example, if the wall is yellow, the effect will look whitest when the color of light effect is bluish.

The system may also be manually calibrated with the help of a camera. For example, the user points his camera at the wall, the light effects are then deployed, the user then has some sort of control, e.g., slider, (optionally per section) to adjust the light effects, and an app then gives some sort of indication of when the light effects are best (e.g., comparable to certain display configuration modes in which the user is asked adjust brightness until a logo stands out with respect to a background).

If the light strip 10 illuminates both a first section of the surface and a second section of the surface and these sections have different colors, the one or more signals would normally be indicative of a first color of the first section of the surface and a (different) second color of the second section of the surface. To use these different colors, the processor 5 may be configured to determine the assignment of the color values to the individually controllable light segments based on the first and second colors of the first and second sections of the surface and/or adjust the dynamicity level of the multi-color light effect based on the first and second colors of the first and second sections of the surface.

The UI in the control app running on the mobile device 33 may reflect the fact that colors need to be adapted due to the background not being white. For example, a pin or an icon that shows the color of the light strip or light strip pixels in the UI may have an indicator that informs the user that the actual color of the strip might be different but when projected on the wall it will display the desired color.

In the embodiment of the light controller 1 shown in FIG. 1, the light controller 1 comprises one processor 5. In an alternative embodiment, the light controller 1 comprises multiple processors. The processor 5 of the light controller 1 may be a general-purpose processor, e.g., ARM-based, or an application-specific processor. The processor 5 of the light controller 1 may run a Unix-based operating system for example. The memory 7 may comprise one or more memory units. The memory 7 may comprise solid-state memory, for example. The memory 7 may be used to store a table of connected lights, for example.

The receiver 3 and the transmitter 4 may use one or more wired or wireless communication technologies, e.g., Ethernet for communicating with the wireless LAN access point 31 and Zigbee for communicating with the light strip 10, for example. In an alternative embodiment, multiple receivers and/or multiple transmitters are used instead of a single receiver and a single transmitter. In the embodiment shown in FIG. 1, a separate receiver and a separate transmitter are used. In an alternative embodiment, the receiver 3 and the transmitter 4 are combined into a transceiver. The light controller 1 may comprise other components typical for a network device such as a power connector. The invention may be implemented using a computer program running on one or more processors.

FIG. 2 shows a second embodiment of the system for controlling a pixelated lighting device. The pixelated lighting device comprises a plurality of individually controllable light segments for illuminating a surface. In this second embodiment, the system is a mobile device 51. FIG. 2 depicts the same pixelated lighting device as FIG. 1: light strip 10. However, in the embodiment of FIG. 2, the mobile device 51 controls the light strip 10 directly, e.g., using Bluetooth.

The light strip 10 depicted in FIGS. 1 and 2 can be controlled either via a light controller (see FIG. 1), e.g., using Zigbee, or directly by a mobile device (see FIG. 2), e.g., using Bluetooth. In an alternative embodiment, a pixelated lighting device can only be controlled via a light controller, e.g., a bridge, or can only be controlled directly by a mobile device. Like the mobile device 33 of FIG. 1, the mobile device 51 of FIG. 2 can be used to control the light strip 10, e g. to select light effects to be rendered on the light strip 10.

The mobile device 51 comprises a transceiver 53, a transmitter 54, a processor 55, a camera 56, memory 57, and a touchscreen display 59. The processor 55 is configured to receive, via camera 56 or touchscreen display 59, one or more signals indicative of one or more colors of the surface and obtain a multi-color light effect to be rendered on a pixelated lighting device. The multi-color light effect defines multiple color values to be rendered simultaneously, e.g., a color gradient. The multi-color light effect may be selected by the user using touchscreen display 59, for example.

The processor 55 is further configured to determine an assignment of the color values to the individually controllable light segments 12-18 of the light strip 10 based on the one or more colors of the surface and/or adjust a dynamicity level of the multi-color light effect based on the one or more colors of the surface, and control, via the transmitter 54, the individually controllable light segments 12-18 of the light strip 10 to render the multi-color light effect according to the assignment and/or with the adjusted dynamicity level.

In the embodiment of the mobile device 51 shown in FIG. 2, the mobile device 51 comprises one processor 55. In an alternative embodiment, the mobile device 51 comprises multiple processors. The processor 55 of the mobile device 1 may be a general-purpose processor, e.g., from ARM or Qualcomm or an application-specific processor. The processor 55 of the mobile device 51 may run an Android or iOS operating system for example. The display 59 may comprise an LCD or OLED display panel, for example. The memory 57 may comprise one or more memory units. The memory 57 may comprise solid state memory, for example.

The receiver 53 and the transmitter 54 may use one or more wireless communication technologies, e.g., Bluetooth, for communicating with the light strip 10. In an alternative embodiment, multiple receivers and/or multiple transmitters are used instead of a single receiver and a single transmitter. In the embodiment shown in FIG. 2, a separate receiver and a separate transmitter are used. In an alternative embodiment, the receiver 53 and the transmitter 54 are combined into a transceiver. The mobile device 51 may comprise other components typical for a mobile device such as a battery and a power connector. The invention may be implemented using a computer program running on one or more processors.

In the embodiments of FIGS. 1 and 2, the system of the invention comprises a light controller or a mobile device. In an alternative embodiment, the system of the invention is a different type of system, e.g., a cloud computer or the pixelated lighting device (or a component thereof). In the embodiments of FIGS. 1 and 2, the system of the invention comprises a single device. In an alternative embodiment, the system of the invention comprises a plurality of devices.

For example, in an alternative embodiment, the system may comprise multiple devices of which one is local, and one is located in the cloud. Receiver 3 and transmitter 4 of FIG. 1 may be part of a local device and processor 5 and memory 7 of FIG. 1 may be part of a cloud device. In this example, calculation and effect generation are performed in the cloud and the light effects are then transmitted to the local device (e.g., a Hue bridge), which forwards them to the lights. Thus, in this alternative embodiment, the local device is only used to receive commands from the cloud device and transmit them the lights.

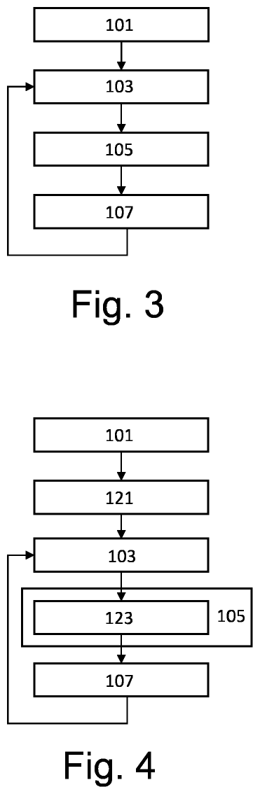

A first embodiment of the method of controlling a pixelated lighting device is shown in FIG. 3. The pixelated lighting device comprises a plurality of individually controllable light segments for illuminating a surface. The surface may be a wall, for example. The method may be performed by the light controller 1 of FIG. 1 or the mobile device 51 of FIG. 2, for example.

A step 101 comprises receiving one or more signals indicative of one or more colors of the surface. The one or more signals may be received, for example, from a camera or a user (device). As an example of the former, users may be able to take a picture of the wall against which the pixelated device shines and provide that as an input for the system to analyze the color content. Alternatively, the one or more signals may be the result of manual calibration, for example.

A step 103 comprises obtaining a multi-color light effect to be rendered on the pixelated lighting device. The multi-color light effect defines multiple color values to be rendered simultaneously. The multi-color light may originate from the user itself (as an ad-hoc trigger), from a time-based event (e.g., schedule), as a response to a system inputs (e.g., sensors, logical conditions), or from third parties (e.g., voice assistants, cloud integrations), for example.

The multi-color light effect may be, for example, a gradient scene. A gradient scene may be defined as a light effect where a color palette is deployed among all pixels but with a certain deployment scheme aimed at e.g., minimizing the variations in transitions among consecutive pixels. A gradient scene may be any set of colors arranged in a specific order, for example arranged in a linear fashion along a curve through a color space. Alternatively, the multi-color light effect may be a light effect where either manually or based on other input (e.g., replicating a photo along a panel), colors are deployed on a pixel basis without necessarily aiming at minimizing the variations in transitions among consecutive pixels.

Elements of a multi-color light effect may not only differ in color but also in brightness, e.g., to enhance or hide the effect of the light effect element. The multi-color light effect may be a dynamic light effect. The dynamicity level of a pixel of a dynamic light effect represents how fast the color and/or brightness of the pixel changes as a function of time. The dynamicity level may be represented by a transition time between successive light settings in a dynamic light effect and/or a contrast between successive light settings in the dynamic light effect, for example. The dynamicity level may be the same for all pixels of a dynamic light effect or at least some of the pixels of the dynamic light effect may differ in dynamicity level. A step 105 comprises determining an assignment of the color values to the individually controllable light segments based on the one or more colors of the surface and/or adjusting a dynamicity level of the multi-color light effect based on the one or more colors of the surface. A step 107 comprises controlling the individually controllable light segments of the pixelated lighting device to render the multi-color light effect according to the assignment and/or with the adjusted dynamicity level. Step 103 may be repeated after step 107, after which the method proceeds as shown in FIG. 3.

A second embodiment of the method of controlling a pixelated lighting device is shown in FIG. 4. This second embodiment of FIG. 4 is an extension of the first embodiment of FIG. 3. In the embodiment of FIG. 4, a step 121 is performed between steps 101 and 103 of FIG. 3 and step 105 of FIG. 3 is implemented by a step 123.

Step 121 comprises detecting whether the surface comprises first and second sections with different colors by detecting whether the one or more signals received in step 101 are indicative of a first color of the first section and a second color of the second section and the first and second colors are different. If a surface with multiple colors is detected, step 121 further comprises determining a location of a boundary between the first and second sections of the surface based on the one or more signals.

Step 123 comprises determining an assignment of the color values to the individually controllable light segments based on the one or more colors of the surface. If a surface with multiple colors was detected in step 121, step 123 comprises determining the assignment of the color values to the individually controllable light segments based on the first and second colors of the first and second sections of the surface and further based on the location of the boundary.

Step 123 may comprise determining color distances between each of the color values of the multi-color light effect and each of the one or more colors of the surface and determining the assignment of the color values to the individually controllable light segments based on the color distances.

Step 123 may comprise determining the distance and/or direction of each section of the surface relative to the (light segments of the) pixelated lighting device. This may be determined based on data from a sensor (e.g., a camera), from a user (device), or from a database. As a first example, the system might obtain information from databases (e.g., 3D rendered models of the home, building management systems, inventories of objects known to be in the space, etc.). As a second example, the system may acquire data from other connected devices such as an indoor (security) camera or a robotic vacuum cleaner.

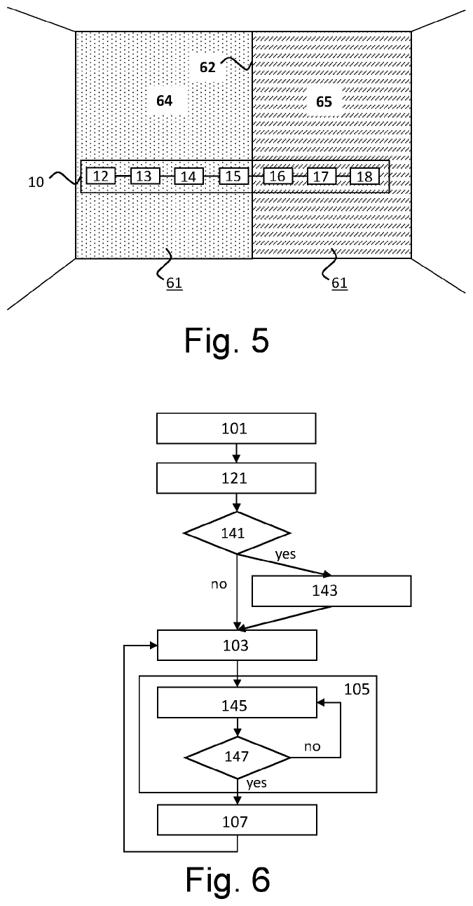

FIG. 5 shows an example of a wall 61 with two colors. A first section of the wall 61 has a first color 64 and a second section of the wall 61 has a (different) second color 65. A boundary 62 separates the two sections of the wall 61. A light strip 10 has been attached to the wall 61. The light strip 10 illuminates portions of the wall 61 located above the light strip 10. Light segments 11 to 15 illuminate a portion of the first section of the wall 61 and light segments 16 to 18 illuminate a portion of the second section of the wall 61.

A third embodiment of the method of controlling a pixelated lighting device is shown in FIG. 6. This third embodiment of FIG. 6 is an extension of the first embodiment of FIG. 3. In the embodiment of FIG. 6, steps 121, 141, and 143 are performed between steps 101 and 103 of FIG. 3 and step 105 of FIG. 3 is implemented by steps 145 and 147.

Step 121 is performed after one or more signals indicative of one or more colors of the surface have been received in step 101. As described in relation to FIG. 4, step 121 comprises detecting whether the surface comprises first and second sections with different colors by detecting whether the one or more signals received in step 101 are indicative of a first color of the first section and a second color of the second section and the first and second colors are different. If a surface with multiple colors is detected, step 121 further comprises determining a location of a boundary between the first and second sections of the surface based on the one or more signals.

Step 141 comprise determining whether a surface with multiple colors was detected in step 121. If so, step 143 is performed next. If not, step 103 is performed next. Step 143 comprises determining a set of segments for each section of the wall that has a different color. In the example of FIG. 5, a first set of segments comprising segments 12-15 and a second set of segments comprising segments 16-18 would be determined. Step 143 may comprise determining the distance and/or direction of each section of the wall relative to the pixelated lighting device, like in step 123 of FIG. 4, in order to determine what set of segments illuminates which section of the wall. Step 103 is performed after step 143.

Step 103 comprises obtaining a multi-color light effect to be rendered on the pixelated lighting device. In the embodiment of FIG. 5, the multi-color light effect is a dynamic light effect. A dynamicity level is associated with the dynamic light effect. Step 145 is performed after step 103.

In its first iteration, step 145 comprises obtain a first dynamicity level for a first set of one more segments of the individually controllable light segments based on the first color and the dynamicity level. Step 147 comprises checking whether a specific dynamicity level has been obtained in step 145 for all of the light segments. If so, step 107 is performed next. If not, step 145 is repeated.

In the next iteration of step 145, step 145 comprises obtaining a next dynamicity level for a next set of one more segments of the individually controllable light segments based on the next color and the dynamicity level. Steps 145 and 147 are repeated until a specific dynamicity level has been determined in step 145 for all of the light segments. At least one of the specific dynamicity levels is different from the dynamicity level associated with the dynamic light effect.

Step 107 comprises controlling the individually controllable light segments of the pixelated lighting device to render the multi-color light effect with the specific dynamicity levels obtained in step 145. This helps make the overall ambiance feel uniform throughout. For example, the pixels against a pale yellow section of a wall could be made to fluctuate faster than the pixels against a neutral white section of the wall.

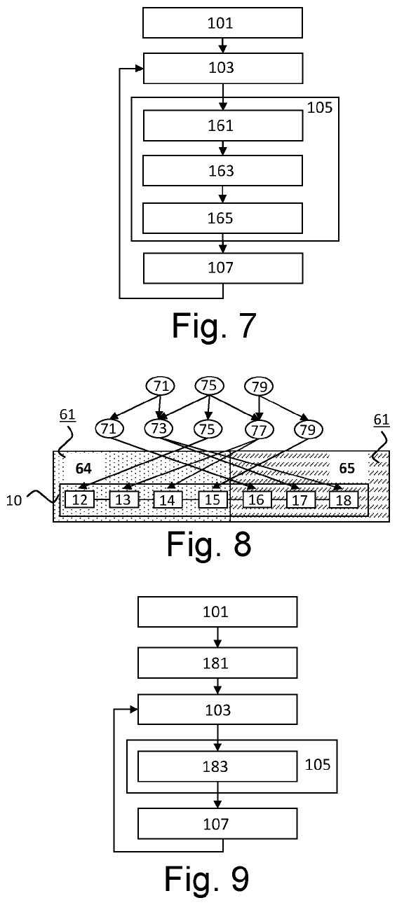

A fourth embodiment of the method of controlling a pixelated lighting device is shown in FIG. 7. This fourth embodiment of FIG. 7 is an extension of the first embodiment of FIG. 3. In the embodiment of FIG. 7, the multi-color light effect obtained in step 103 comprises a color gradient and step 105 is implemented by steps 161, 163, and 165.

Step 161 comprises mapping a start of the color gradient to one of the individually controllable light segments based on the one or more colors of the surface. Step 163 comprises mapping an end of the color gradient to a further one of the individually controllable light segments based on the one or more colors of the surface. Step 165 comprises mapping the other color values of the color gradient to the other individually controllable light segments. As a result, the gradient is shifted on the pixelated lighting device, e.g., along the length of the light strip, such that the most suitable colors are co-located close to the area of the wall where the effect suffers the least.

For example, if the user wants to deploy a rainbow gradient, the gradient may be shifted to ensure that the pixels that take up the yellow, orange, and lime colors are the ones against a yellow wall or yellow section of a wall, as the natural color of the wall (section) would then help enhance those colors, whereas if blue and green had been placed there, the contrast would have impacted the ambiance created.

Steps 161-165 may comprise selecting a segment of the color gradient, selecting one or more of the individually controllable light segments based on the one or more colors of the surface, mapping the selected segment of the color gradient to the selected one or more of the individually controllable light segments, and repeating this for one or more other segments of the color gradient. A first segment of the color gradient may be mapped to a relatively larger number of light segments than a second segment (relative to the size of the gradient segment). This means that the first segment is expanded, the second segment is shrunk, or both. Thus, segments of pixels will no longer have uniform distributions but instead some colors will be deployed among more pixels whereas others among fewer.

For example, if the density of colors in the gradient is high enough that even if yellow, orange, and lime would have been shifted towards the pixels against a pale yellow wall, there would still have been green and red pixels within that area, this would have broken the ambiance being created. This may be mitigated by using more pixels to cover the yellow, orange, and lime pixels and fewer pixels to cover red, blue, and green in the remaining parts of the pixelated lighting device.

FIG. 8 shows an example assignment of values of a color gradient to segments of a light strip. In this example a user defines a color gradient by specifying three colors 71, 75, and 79. A more detailed color gradient is then determined from these three colors 71, 75, and 79 by using interpolation. This more detailed color gradient comprises five colors 71, 73, 75, 77, and 79. Color 73 has been interpolated from colors 71 and 75 and color 77 has been interpolated from colors 75 and 79. In an alternative example, the user specifies more than three color and/or the detailed color gradient comprises more than five colors.

Since mapping colors 77 and 79 to the light segments illuminating the section of the wall 61 that has color 65 would have impacted the created ambiance, colors 77 and 79 are instead mapped to the light segments illuminating the section of the wall 61 that has color 64. Color 71, the start of the gradient, is mapped to light segment 16. Color 79, the end of the gradient, is mapped to light segment 15. Color 73 is mapped to light segments 17 and 18. Color 75 is mapped to light segment 12. Color 77 is mapped to light segments 13 and 14. In the example of FIG. 8, the left part of the color gradient, from color 71 to color 75, has been expanded, and the right part of the color gradient, from color 75 to color 79, has also been expanded. The right part of the color gradient has been expanded more than the left part of the color gradient.

A fifth embodiment of the method of controlling a pixelated lighting device is shown in FIG. 9. This fifth embodiment of FIG. 9 is an extension of the first embodiment of FIG. 3. In the embodiment of FIG. 9, a step 181 is performed between steps 101 and 103 of FIG. 3 and step 105 is implemented by a step 183.

Step 181 comprises determining a degree of visibility for each of the individually controllable light segments. The degree of visibility may be determined based on the one or more signals received in step 101, for example. As described in relation to FIG. 3, the one or more signals may be received, for example, from a camera or a user (device). The camera may be annotated by the user indicating the actual area of interest (to avoid adjusting based on colors which are within the frame but will not affect the ambiance). The user may be able to do this afterwards or in real-time (using augmented reality). Alternatively, the user may be able to capture a short video where specific light patterns are applied to the pixelated device and the method may comprise comparing frames within that video to spot which areas are the ones affected by a pixelated device.

Step 183 comprises determining an assignment of the color values to the individually controllable light segments based on the one or more colors of the surface and based on the degrees of visibility determined in step 181 and/or adjusting a dynamicity level of the multi-color light effect based on the one or more colors of the surface and on the degrees of visibility determined in step 181.

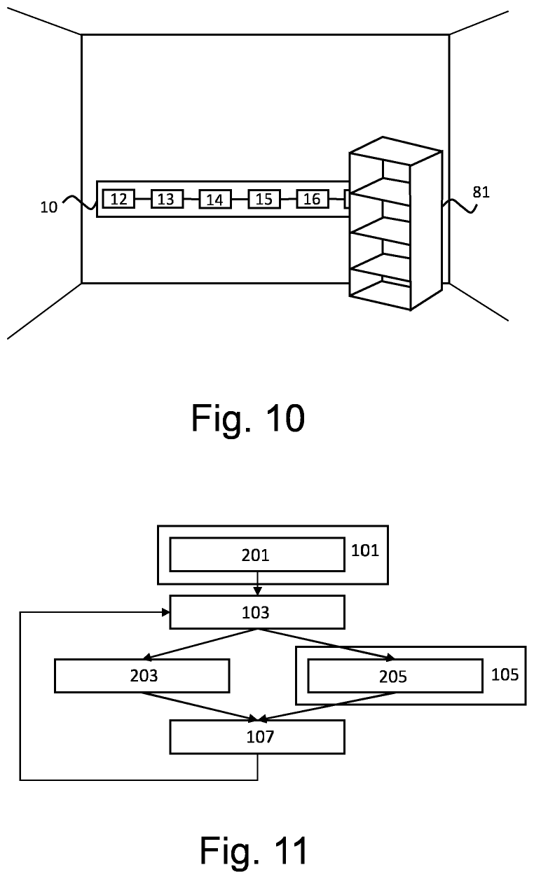

FIG. 10 shows an example in which a light strip 10 is partly obscured by a bookcase 81. The degree of visibility of light segments 17 and 18 is low and the degree of visibility of light segments 12 to 16 is high. Since the degree of visibility of light segments 17 and 18 is low, which color is rendered by the light segments 17 and 18 does not impact the created ambience (much).

A sixth embodiment of the method of controlling a pixelated lighting device is shown in FIG. 11. The pixelated lighting device comprises a plurality of individually controllable light segments for illuminating a surface. The method may be performed by the light controller 1 of FIG. 1 or the mobile device 51 of FIG. 2, for example.

A step 201 comprises receiving one or more signals indicative of one or more colors of the surface. The one or more signals are further indicative of one or more textures and/or one or more reflective properties of the surface.

A step 103 comprises obtaining a multi-color light effect to be rendered on the pixelated lighting device. The multi-color light effect defines multiple color values to be rendered simultaneously. The multi-color light effect further defines brightness values associated with the multiple color values. A step 203 and a step 205 are performed after step 103.

Step 203 comprises adjusting one or more of the brightness values based on the one or more colors of the surface. Step 205 comprises determining an assignment of the color values to the individually controllable light segments based on the one or more colors of the surface and further based on the one or more textures and/or the one or more reflective properties of the surface and/or adjusting a dynamicity level of the multi-color light effect based on the one or more colors of the surface and further based on the one or more textures and/or the one or more reflective properties of the surface.

It is beneficial to taken into account the texture of the surface, especially if different sections of the surface have different textures, since going from a smooth to a rugged surface will also affect the deployment of light on it. If the surface is textured, it is further beneficial to take into the angle of incidence.

Step 107 comprises controlling the individually controllable light segments of the pixelated lighting device to render the multi-color light effect according to the assignment and/or with the adjusted dynamicity level. In step 107, the individually controllable light segments are also controlled to render the multi-color light effect with the one or more brightness values adjusted in step 103. Step 103 may be repeated after step 107, after which the method proceeds as shown in FIG. 11.

The embodiments of FIGS. 3, 4, 6, 7, 9, and 11 differ from each other in multiple aspects, i.e., multiple steps have been added or replaced. In variations on these embodiments, only a subset of these steps is added or replaced and/or one or more steps is omitted. As a first example, step 203 may be omitted from the embodiment of FIG. 11. As a second example, one or more of the embodiments of FIGS. 4, 6, 7, 9, and 11 may be combined.

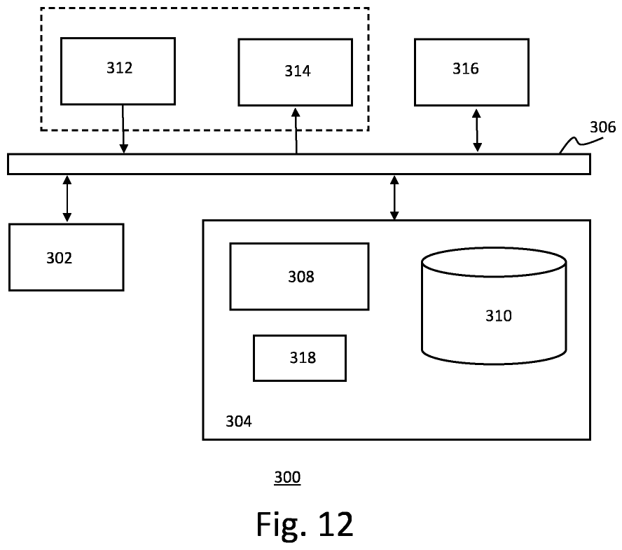

FIG. 12 depicts a block diagram illustrating an exemplary data processing system that may perform the method as described with reference to FIGS. 3, 4, 6, 7, 9, and 11.

As shown in FIG. 12, the data processing system 300 may include at least one processor 302 coupled to memory elements 304 through a system bus 306. As such, the data processing system may store program code within memory elements 304. Further, the processor 302 may execute the program code accessed from the memory elements 304 via a system bus 306. In one aspect, the data processing system may be implemented as a computer that is suitable for storing and/or executing program code. It should be appreciated, however, that the data processing system 300 may be implemented in the form of any system including a processor and a memory that is capable of performing the functions described within this specification.

The memory elements 304 may include one or more physical memory devices such as, for example, local memory 308 and one or more bulk storage devices 310. The local memory may refer to random access memory or other non-persistent memory device(s) generally used during actual execution of the program code. A bulk storage device may be implemented as a hard drive or other persistent data storage device. The processing system 300 may also include one or more cache memories (not shown) that provide temporary storage of at least some program code in order to reduce the quantity of times program code must be retrieved from the bulk storage device 310 during execution. The processing system 300 may also be able to use memory elements of another processing system, e.g. if the processing system 300 is part of a cloud-computing platform.

Input/output (I/O) devices depicted as an input device 312 and an output device 314 optionally can be coupled to the data processing system. Examples of input devices may include, but are not limited to, a keyboard, a pointing device such as a mouse, a microphone (e.g. for voice and/or speech recognition), or the like. Examples of output devices may include, but are not limited to, a monitor or a display, speakers, or the like. Input and/or output devices may be coupled to the data processing system either directly or through intervening I/O controllers.

In an embodiment, the input and the output devices may be implemented as a combined input/output device (illustrated in FIG. 12 with a dashed line surrounding the input device 312 and the output device 314). An example of such a combined device is a touch sensitive display, also sometimes referred to as a “touch screen display” or simply “touch screen”. In such an embodiment, input to the device may be provided by a movement of a physical object, such as e.g. a stylus or a finger of a user, on or near the touch screen display.

A network adapter 316 may also be coupled to the data processing system to enable it to become coupled to other systems, computer systems, remote network devices, and/or remote storage devices through intervening private or public networks. The network adapter may comprise a data receiver for receiving data that is transmitted by said systems, devices and/or networks to the data processing system 300, and a data transmitter for transmitting data from the data processing system 300 to said systems, devices and/or networks. Modems, cable modems, and Ethernet cards are examples of different types of network adapter that may be used with the data processing system 300.

As pictured in FIG. 12, the memory elements 304 may store an application 318. In various embodiments, the application 318 may be stored in the local memory 308, the one or more bulk storage devices 310, or separate from the local memory and the bulk storage devices. It should be appreciated that the data processing system 300 may further execute an operating system (not shown in FIG. 12) that can facilitate execution of the application 318. The application 318, being implemented in the form of executable program code, can be executed by the data processing system 300, e.g., by the processor 302. Responsive to executing the application, the data processing system 300 may be configured to perform one or more operations or method steps described herein.

FIG. 12 shows the input device 312 and the output device 314 as being separate from the network adapter 316. However, additionally or alternatively, input may be received via the network adapter 316 and output be transmitted via the network adapter 316. For example, the data processing system 300 may be a cloud server. In this case, the input may be received from and the output may be transmitted to a user device that acts as a terminal.

Various embodiments of the invention may be implemented as a program product for use with a computer system, where the program(s) of the program product define functions of the embodiments (including the methods described herein). In one embodiment, the program(s) can be contained on a variety of non-transitory computer-readable storage media, where, as used herein, the expression “non-transitory computer readable storage media” comprises all computer-readable media, with the sole exception being a transitory, propagating signal. In another embodiment, the program(s) can be contained on a variety of transitory computer-readable storage media. Illustrative computer-readable storage media include, but are not limited to: (i) non-writable storage media (e.g., read-only memory devices within a computer such as CD-ROM disks readable by a CD-ROM drive, ROM chips or any type of solid-state non-volatile semiconductor memory) on which information is permanently stored; and (ii) writable storage media (e.g., flash memory, floppy disks within a diskette drive or hard-disk drive or any type of solid-state random-access semiconductor memory) on which alterable information is stored. The computer program may be run on the processor 302 described herein.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of embodiments of the present invention has been presented for purposes of illustration, but is not intended to be exhaustive or limited to the implementations in the form disclosed. Many modifications and variations will be apparent to those of ordinary skill in the art without departing from the scope and spirit of the present invention. The embodiments were chosen and described in order to best explain the principles and some practical applications of the present invention, and to enable others of ordinary skill in the art to understand the present invention for various embodiments with various modifications as are suited to the particular use contemplated.

1. A system for controlling a pixelated lighting device, said pixelated lighting device comprising a plurality of individually controllable light segments for illuminating a surface, said system comprising:
at least one input interface;
at least one control interface; and
at least one processor configured to:
receive, via said at least one input interface, one or more signals indicative of one or more colors of said surface, wherein said one or more signals are indicative of a first color of a first section of said surface, and a second color of a second section of said surface, said first and second colors being different,
obtain a multi-color light effect to be rendered on said pixelated lighting device, said multi-color light effect defining multiple color values to be rendered simultaneously,
determine an assignment of said color values to said individually controllable light segments based on said first and second colors of said first and second sections of said surface and/or adjust a dynamicity level of said multi-color light effect based on said first and second colors of said first and second sections of said surface, and
control, via said at least one control interface, said individually controllable light segments of said pixelated lighting device to render said multi-color light effect according to said assignment and/or with said adjusted dynamicity level.

2. (canceled)

3. A system as claimed in claim 1, wherein said at least one processor is configured to:
determine a location of a boundary between said first and second sections of said surface based on said one or more signals, and
determine said assignment of said color values to said individually controllable light segments (12-18) further based on said location of said boundary and/or adjust said dynamicity level of said multi-color light effect further based on said location of said boundary.

4. A system as claimed in claim 1, wherein said multi-color light effect is a dynamic light effect, said dynamicity level is associated with said dynamic light effect, and said at least one processor is configured to obtain a first dynamicity level for a first segment of said individually controllable light segments based on said first color and said dynamicity level and a second dynamicity level for a second segment of said individually controllable light segments based on said second color and said dynamicity level.

5. A system as claimed in claim 1, wherein said multi-color light effect comprises a color gradient.

6. A system as claimed in claim 5, wherein said at least one processor is configured to determine said assignment by mapping a start of said color gradient to one of said individually controllable light segments based on said one or more colors of said surface and mapping an end of said color gradient to a further one of said individually controllable light segments based on said one or more colors of said surface.

7. A system as claimed in claim 5, wherein said at least one processor is configured to determine said assignment by selecting a segment of said color gradient and selecting one or more of said individually controllable light segments based on said one or more colors of said surface and control said individually controllable light segments of said pixelated lighting device by controlling said one or more selected light segments to render said segment of said color gradient.

8. A system as claimed in claim 1, wherein said at least one processor is configured to determine color distances between each of said color values and each of said one or more colors of said surface and determine said assignment of said color values to said individually controllable light segments based on said color distances.

9. A system as claimed in claim 1, wherein said at least one processor is configured to determine a degree of visibility for each of said individually controllable light segments and determine said assignment of said color values to said individually controllable light segments further based on said degrees of visibility and/or adjust said dynamicity level of said multi-color light effect further based on said degrees of visibility.

10. A system as claimed in claim 1, wherein said dynamicity level is represented by a transition time between successive light settings in a dynamic light effect and/or a contrast between successive light settings in said dynamic light effect.

11. A system as claimed in claim 1, wherein said one or more signals are further indicative of one or more textures and/or one or more reflective properties of said surface and said at least one processor is configured to determine said assignment of said color values to said individually controllable light segments further based on said one or more textures and/or said one or more reflective properties of said surface and/or adjust said dynamicity level of said multi-color light effect further based on said one or more textures and/or said one or more reflective properties of said surface.

12. A system as claimed in claim 1, wherein said multi-color light effect further defines brightness values associated with said multiple color values and said at least one processor is configured to:
adjust one or more of said brightness values based on said one or more colors of said surface, and
control said individually controllable light segments of said pixelated lighting device by controlling said individually controllable light segments to render said multi-color light effect with said adjusted one or more brightness values.

13. A system as claimed in claim 1, wherein said one or more signals are indicative of plurality of colors and said at least one processor is configured to:
receive said one or more signals from a sensor,
determine a color by determining a dominant color in said plurality of colors and/or by selecting said color from said plurality of colors based on a location on said surface, said location being illuminated by said pixelated lighting device, and
determine said assignment of said color values to said individually controllable light segments based on said color and/or adjust said dynamicity level of said multi-color light effect based on said color.

14. A method of controlling a pixelated lighting device, said pixelated lighting device comprising a plurality of individually controllable light segments for illuminating a surface, said method comprising:
receiving one or more signals indicative of one or more colors of said surface, wherein said one or more signals are indicative of a first color of a first section of said surface, and a second color of a second section of said surface, said first and second colors being different;
obtaining a multi-color light effect to be rendered on said pixelated lighting device, said multi-color light effect defining multiple color values to be rendered simultaneously;
determining an assignment of said color values to said individually controllable light segments based on said first and second colors of said first and second sections of said surface and/or adjust a dynamicity level of said multi-color light effect based on said first and second colors of said first and second sections of said surface; and
controlling said individually controllable light segments of said pixelated lighting device to render said multi-color light effect according to said assignment and/or with said adjusted dynamicity level.

15. A computer program product for a computing device, the computer program product comprising computer program code to perform the method of claim 14 when the computer program product is run on a processing unit of the computing device.

16. A system as claimed in claim 1, wherein determining the assignment of said color values to said individually controllable light segments comprises determining a distance and/or a direction of the first section of said surface and the second section of said surface relative to the plurality of individually controllable light segments of the pixelated lighting device.
